(19) United States
(12) Patent Application Publication
(10) Pub. No.: US 2008/0140562 A1
(43) Pub. Date: Jun. 12, 2008

(54) Invoice Financing

(75) Inventor: Neville Winston Joseph Kerdachi, Durban (ZA)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Validation Clearing Bureau(Proprietary)Limited, Stamfordhill (ZA)

(21) Appl. No.: 11/814,869

(22) PCT Filed: Oct. 25, 2005
(86) PCT No.: PCT/IB05/03178

§ 371 Date: Jul. 26, 2007

(30) Foreign Application Priority Data
Jan. 27, 2005 (ZA) 2005/0820

(51) Int. Cl. G06Q 40/00; G06Q 90/00

(52) U.S. Cl. 705/38; 705/35; 705/40

(57) ABSTRACT

An electronic invoice financing system (10) includes a supplier invoice transmitter (12) to transmit details of a supplier invoice to a debtor approval manager (16) operable by, or operable to assist, at least one financial institution which finances invoices issued by the supplier, and a debtor accounts payable transmitter (14) to transmit details of a supplier invoice approved for payment, to said debtor approval manager (16). The debtor approval manager (16) includes, or has access to, a database of approved debtors and is configured to receive invoice details from the supplier invoice transmitter (12) and from the debtor accounts payable transmitter (14), and to indicate the status of an invoice for which details were received as validated or verified.

THIS INVENTION relates to invoice financing. In particular, it relates to an electronic invoice financing system, an electronic debtor approval manager, a method of financing an invoice and a method of providing support to a financial institution involved in invoice financing.

Factoring is the practice of buying invoices at a discount and taking responsibility for collecting the payments due on the invoices. In essence, it thus involves the financing of invoices. This is a risky activity, as the factor is taking the entire risk that the debtor might not pay the invoice, for whatever reason, e.g. insolvency, repudiation, fraud etc. There is thus substantial time and cost involved for the factor to verify delivery of services and goods for which invoices have been issued in order to prevent fraud on the factor and in order to reduce the risk of the factoring transaction. As will be appreciated, there is thus a need for means to reduce the time and cost involved in the financing of invoices.

According to one aspect of the invention, there is provided an electronic invoice financing system which includes

a supplier invoice transmitter configured to transmit details of a supplier invoice electronically from a supplier to a debtor approval manager operable by, or operable to assist, at least one financial institution which finances invoices issued by the supplier;

a debtor accounts payable transmitter which is programmable electronically to transmit details of a supplier invoice approved for payment, to said debtor approval manager; and

said debtor approval manager which includes, or which has access to, a database of approved debtors and which is configured to receive invoice details from the supplier invoice transmitter and from the debtor accounts payable transmitter, the debtor approval manager being programmed or programmable selectively to indicate the status of an invoice for which details were received from the supplier invoice transmitter as validated or verified, or non-validated, depending on whether or not corresponding invoice details were also received from the debtor accounts payable transmitter and whether or not the debtor is an approved debtor, and then either (I) to transmit the invoice status information to a financial institution so that the financial institution can then consider providing credit to the supplier, to the value of a predetermined percentage of the value of the validated supplier invoice, or (II) to provide credit on behalf of the financial institution to the supplier, to the value of a predetermined percentage of the value of the validated supplier invoice.

By “financial institution” is meant any financial institution providing credit to others, such as a financier, finance house, bank or the like.

Typically, the supplier invoice transmitter and/or the debtor accounts payable transmitter is/are configured to transmit the invoice details online to the debtor approval manager assisting the financial institution or operated by or on behalf of the financial institution.

The system may include a credit facility manager operated or operable by the financial institution and configured to receive, e.g. online or electronically, invoice details from the supplier invoice transmitter. Thus, the supplier invoice transmitter may be configured to transmit e.g. electronically details of a supplier invoice to the credit facility manager, in addition to transmitting details of a supplier invoice to the debtor approval manager.

The financial institution typically provides an account for the supplier and it is thus an overdraft limit on this account which is typically raised by the financial institution or the debtor approval manager when credit is supplied to the supplier on the strength of a supplier invoice that is validated. Typically, this account is thus a revolving credit account, which is also a current account held by the supplier with the financial institution. The debtor approval manager or preferably the credit facility manager may be configured to manage said supplier account on behalf of the financial institution. The debtor approval manager or preferably the credit facility manager may also be configured to provide the financial institution and/or the supplier with a statement of the supplier's account with the financial institution. The statement typically includes information showing at least the amount of credit available to the supplier.

When the debtor approval manager is configured to transmit invoice status information to the financial institution (typically to the credit facility manager) in order for the financial institution to consider providing credit or finance to the supplier, the status information may be in the form of said account statement or merely in the form of a credit limit advice, thereby informing the financial institution of what the credit limit on the supplier's account must be, instead of actual individual invoice statuses. Instead, the debtor approval manager may be configured to transmit actual individual invoice statuses.

Preferably, the account statement also shows the amounts of any user or transaction fees charged to the supplier for making use of the invoice financing system. The fees can, for example, be charged every time details of an invoice are transmitted by the supplier invoice transmitter to the debtor approval manager, irrespective of whether or not the financial institution is providing finance or credit on the invoice, or it can only be charged for each invoice on which the financial institution is providing credit to the supplier. The basis on which the supplier is charged for the use of the invoice financing system will typically be agreed upon between the supplier and the financial institution and/or an entity operating the debtor approval manager.

The account statement may also show other, non-user fees charged by the financial institution, e.g. any interest amounts or discount amounts charged by the financial institution to the supplier for the credit or finance provided by the financial institution to the supplier.

When the debtor approval manager is configured to manage the supplier's account with the financial institution, the debtor approval manager may be configured to transfer at least a portion of said user or transaction fees into an account, or to credit said account, of an entity managing or operating the debtor approval manager, and/or providing debtor creditworthiness information to the debtor approval manager. Instead, the credit facility manager may be configured to transfer at least a portion of said user or transaction fees charged to the supplier into an account, or to credit said account, of an entity managing or operating the debtor approval manager, and/or providing debtor creditworthiness information to the debtor approval manager.

When the debtor approval manager is configured to manage the supplier's account with the financial institution, the debtor approval manager may also be configured to transfer an underwriting premium, charged to the supplier, into an account, or to credit said account, of an entity underwriting the financial institution for potential losses that may be incurred by the financial institution as a result of providing credit to the supplier on the basis of a validated invoice. Instead, the credit facility manager may be configured to transfer an underwriting premium, charged to the supplier, into an account, or to credit said account, of an entity underwriting the financial institution for potential losses that may be incurred by the financial institution as a result of providing credit to the supplier on the basis of a validated invoice.

When the debtor approval manager is configured to transmit the invoice status information to a financial institution, the debtor approval manager is typically configured electronically, e.g. online, to transmit the invoice status information to the financial institution. The debtor approval manager may also be configured electronically, e.g. online, to transmit details of a non-validated invoice to the financial institution. Such a non-validated invoice may thus be an invoice rejected by a debtor or an invoice for which details were received from a debtor which is not an approved debtor, i.e. an invoice rejected by the debtor approval manager due to the debtor not being on the database of approved debtors.

The debtor approval manager and/or the credit facility manager may be configured to manage a control account or register, which control account or register includes records of submitted details of supplier invoices. The records may include details of validated and non-validated invoices and may thus include a validation status indicator. The debtor approval manager may be configured to change the status indicator of a non-validated invoice in a record to a validated invoice under predetermined conditions, and then either to transmit the revised invoice status information to a financial institution so that the financial institution can then consider providing credit to the supplier, to the value of a predetermined percentage of the value of the validated supplier invoice, or provide credit on behalf of the financial institution to the supplier, to the value of a predetermined percentage of the value of the validated supplier invoice.

When the credit facility manager is configured to manage a control account or register which includes records of submitted details of supplier invoices, the control account may include at least two sub-accounts. One sub-account may include details of all invoices received from the supplier invoice transmitter and one sub-account may include details of only those invoices validated or verified by the debtor approval manager.

According to another aspect of the invention, there is provided an electronic debtor approval manager which includes, or which has access to, a database of approved debtors, the debtor approval manager being configured to receive invoice details from a supplier and a debtor, the debtor approval manager further being programmed or programmable selectively to indicate the status of an invoice for which details were received from the supplier as validated or verified, or non-validated, depending on whether or not corresponding invoice details were also received from the debtor and whether or not the debtor is an approved debtor.

The electronic debtor approval manager may be configured either (I) to transmit the invoice status information to a financial institution so that the financial institution can then consider providing credit to the supplier, to the value of a predetermined percentage of the value of the validated invoice, or (II) to provide credit on behalf of the financial institution to the supplier, to the value of a predetermined percentage of the value of the validated invoice.

The debtor approval manager may be configured to manage an account for the supplier on behalf of the financial institution. The debtor approval manager may also be configured to provide the financial institution and/or the supplier with a statement of the supplier's account with the financial institution. The statement may be as hereinbefore described.

Preferably, the account statement also shows the amounts of any user or transaction fees charged to the supplier for making use of the debtor approval manager. The fees can, for example, be charged every time details of an invoice are received by the debtor approval manager, irrespective of whether or not the financial institution is providing finance or credit on the invoice, or it can only be charged for each invoice on which the financial institution is providing credit to the supplier. The basis on which the supplier is charged for the use of the debtor approval manager will typically be agreed upon between the supplier and the financial institution and/or an entity operating the debtor approval manager.

The debtor approval manager may further be as hereinbefore described with reference to the electronic invoice financing system.

According to a further aspect of the invention, there is provided a method of financing an invoice, the method including

validating or verifying an invoice issued by a supplier to a debtor by receiving online, from both the supplier and the debtor, details of said invoice issued by the supplier to the debtor and comparing the invoice details received from the supplier and from the debtor, and further receiving or obtaining online confirmation that the debtor is creditworthy; and

providing credit to the supplier, or recommending the provision of credit by a financial institution to the supplier, to the value of a predetermined percentage of the value of the validated invoice.

Receiving online details of an invoice issued by a supplier to a debtor typically includes receiving said details over an electronic communications system or network such as the internet or another computer network. The communications system or network may be a secure system or network. The details of the invoice may be transmitted by the supplier and the debtor, which may transmit details of a plurality of invoices in batches.

Recommending the provision of credit by the financial institution to the supplier may include merely advising the financial institution that a particular invoice has been validated or verified, and advising the financial institution of the face value of the invoice for which the invoice has been validated.

The method may include taking out insurance in respect of the risk, or underwriting the risk, that the debtor may default on any payment due in terms of the invoice. Thus, validating an invoice may also include taking out insurance in respect of the risk, or underwriting the risk, that the debtor may default on any payment due in terms of the invoice.

The method typically includes raising a user or transaction fee, payable by the supplier, for financing the invoice. This user or transaction fee will usually be in addition to any non-user fees charged, e.g. any interest amounts or discount amounts charged for providing credit or finance to the supplier, as hereinbefore described. The user or transaction fees may be raised on the basis as hereinbefore described. The method may include crediting an underwriter with an underwriting premium for underwriting or insuring the financing of the invoice.

Receiving or obtaining online confirmation that the debtor is creditworthy may include checking or searching a database of approved debtors to determine if the debtor is an approved, creditworthy debtor. The method may also include crediting a credit guarantee entity with a portion of the transaction or user fee for providing information on the creditworthiness of the debtor and/or for monitoring the creditworthiness of the debtor.

The method may include managing an account for the supplier and may also include providing the supplier, online or otherwise, with an account statement. The account and the account statement may be as hereinbefore described.

The method may include managing a control account or register as hereinbefore described.

According to yet another aspect of the invention, there is provided a method of providing support to a financial institution involved in invoice financing, which method includes receiving online details of an invoice issued to a debtor, with confirmation from the debtor that the invoice was received from a supplier to the debtor and that the invoice is payable by the debtor;

investigating the creditworthiness of the debtor; and

validating or verifying the invoice online for a financial institution in order for the financial institution to consider providing credit to the supplier on the strength of the validated invoice, the invoice being validated only if the investigation of the creditworthiness of the debtor has confirmed that the debtor is creditworthy.

The method may include receiving online details of said invoice from said supplier and from said debtor. The invoice may be validated also only if the invoice details received from the supplier correspond to a predetermined degree with the invoice details received from the debtor, or the invoice may be validated for a lower amount where the invoice details received from the debtor is for said lower amount, where the lower amount is less than the face value of the invoice as included in the invoice details received from the supplier.

Investigating the creditworthiness of the debtor may include checking or searching an electronic database of approved debtors to determine if the debtor is an approved debtor.

The invoice may also be validated or verified only if payment or partial payment of the invoice is assured by an underwriter.

The invention will now be described, by way of example only, with reference to the accompanying diagrammatic drawings in which

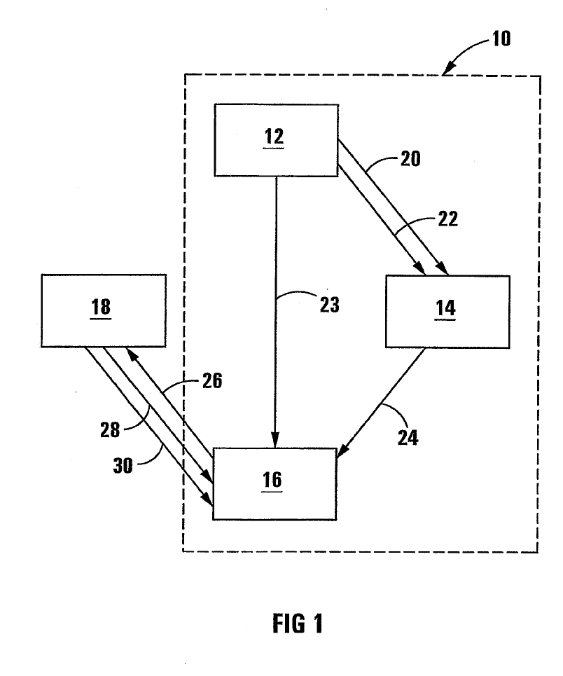

FIG. 1 shows a schematic diagram of one embodiment of an electronic invoice financing system in accordance with the invention;

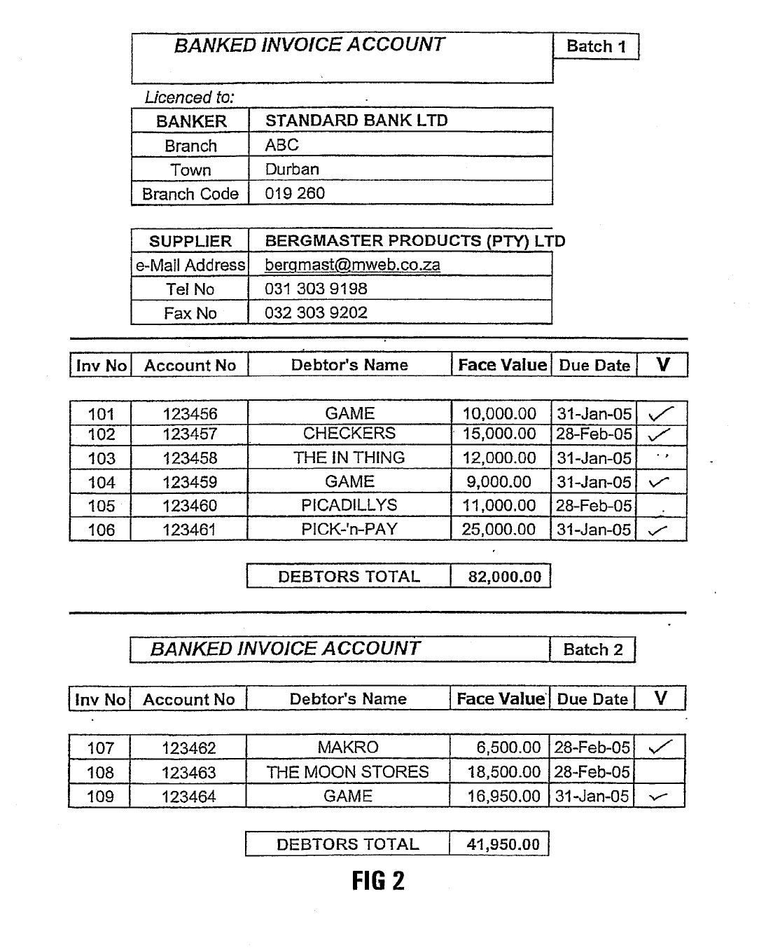

FIG. 2 shows an example of an account or register of supplier invoices kept by a debtor approval manager;

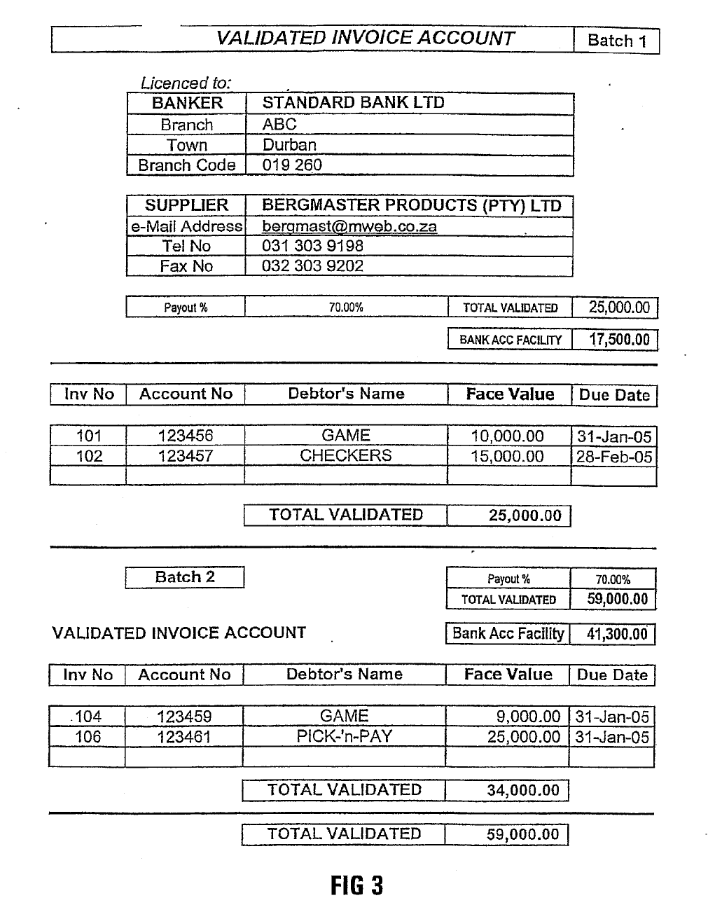

FIG. 3 shows an example of an account or register of validated supplier invoices kept by the debtor approval manager;

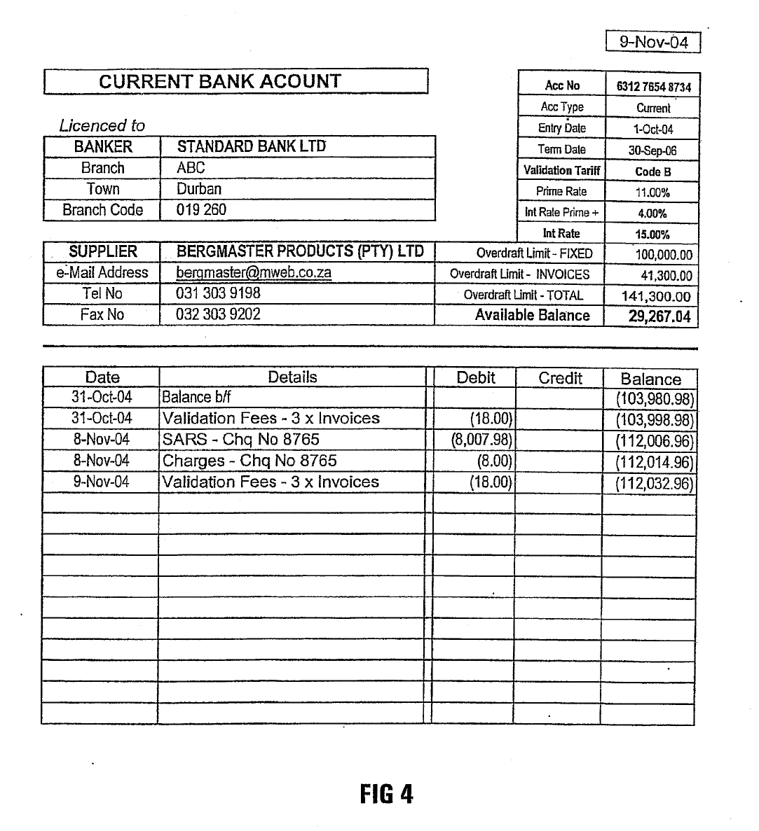

FIG. 4 shows an example of a statement issued by a financial institution to a supplier;

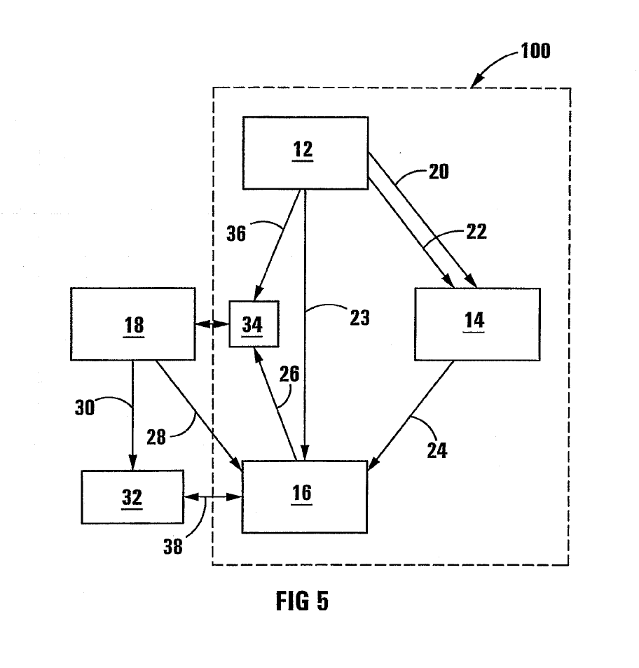

FIG. 5 shows a schematic diagram of another embodiment of an invoice financing system in accordance with the invention; and

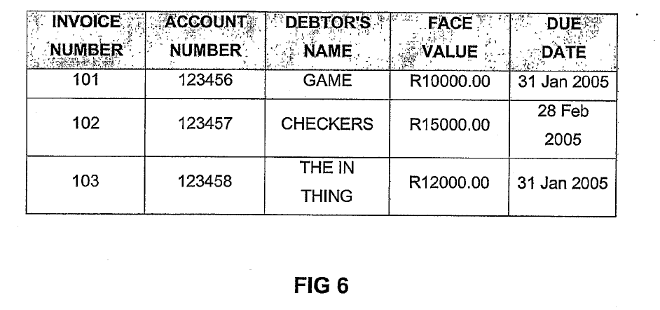

FIG. 6 shows an example of a data transmission from a supplier invoice transmitter.

Referring to FIG. 1 of the drawings, reference numeral 10 generally indicates an electronic invoice financing system in accordance with the invention. The system 10 includes an electronic supplier invoice transmitter 12, an electronic debtor accounts payable transmitter 14 and an electronic debtor approval manager 16. FIG. 1 also shows a financial institution or bank, indicated by reference numeral 18, which makes use of the system 10. Although the system 10 will generally be used by a plurality of financial institutions 18 and will include a plurality of the supplier invoice transmitters 12 and a plurality of the debtor accounts payable transmitters 14, only one of each is shown in FIG. 1 for simplicity. Also, the debtor approval manager 16 of the system 10 may be in communication with debtor approval managers of other similar or like systems, e.g. in other countries, for purposes of international trade.

Typically, the components 12, 14, 16 are in the form of programmed or programmable computers or similar processing devices which are capable of communicating with at least some of the others. Thus, the components 12, 14, 16 are typically connected to a communications network such as the internet or a wide area network or the like and communicates using a standard or conventional communications protocol. Typically, the debtor approval manager 16 communicates with a computer system of the bank 18 connected to the communications network. It is however to be appreciated that the debtor approval manager 16 may also form part of the bank's computer system. If desired, the communications network may be a secure network, relying on encryption technology or the like to ensure the security and privacy of information exchanged between the components 12, 14, 16 and the bank 18.

The supplier invoice transmitter 12 is provided with software enabling the transmitter 12 to transmit details of invoices, in the form of invoice records, electronically from the transmitter 12 to the debtor approval manager 16. Preferably, the software operated by the supplier invoice transmitter 12 also allows the generation of the invoices and then extracts details of the invoices for transmission. The transmitter 12 may thus form part of or interact with accounting software operated by a supplier of goods or services, but it is to be appreciated that the invoice details can also be manually fed into the transmitter 12.

The debtor accounts payable transmitter 14 is configured to accept data input whereby details of invoices can be entered and an invoice marked as approved or rejected, thereby creating invoice records. Furthermore, the debtor accounts payable transmitter 14 is capable of transmitting the invoice records electronically over the communications network to the debtor approval manager 16, if so desired.

The debtor approval manager 16 includes a database of approved debtors and is provided with a suitable search engine enabling searching of the database. In other embodiments, the database is not part of the debtor approval manager 16, but the debtor approval manager 16 has online access to the database. Software provided for the debtor approval manager 16 also enables the debtor approval manager 16 selectively to mark an invoice record received from the supplier invoice transmitter 12 as validated (verified) or non-validated or non-verified or rejected depending inter alia on whether or not corresponding, confirmatory invoice details were received from the debtor accounts payable transmitter 14 and depending on whether or not the debtor appears as an approved debtor in the database of approved debtors.

The supplier invoice transmitter 12 is typically located at and operated by a supplier of goods and/or services such as a manufacturer or wholesaler, and the debtor accounts payable transmitter 14 is located with and operated by a receiver of such goods and/or services, such as a retailer. The debtor approval manager 16 may be operated by an independent entity providing an input to the invoice financing process enabled by the electronic invoice financing system 10. It is however envisaged that the debtor approval manager 16 will be operated by an entity managed or owned by and providing a service to a group of separate, independent financial institutions such as a group of banks. In particular, it is envisaged that the debtor approval manager 16 will be operated by the Automated Clearing Bureau or similar entity of the country or jurisdictional area in which the system 10 is being employed. The database of approved debtors may be supplied by an outside organisation conducting research on the creditworthiness of entities, and which preferably also acts as an underwriter.

The system 10 is used by suppliers and financial institutions to facilitate the buying by the financial institutions of invoices issued by the suppliers and which the financial institutions are prepared to finance. This buying of invoices is done at a discount or for a fee and the financial institutions take responsibility for collecting the payments due on these invoices, whilst charging interest on any credit provided to the suppliers.

The process of invoice financing is initiated by the supplier and a financial institution, such as the bank 18, entering into an invoice financing and cession agreement. The supplier and the bank 18 notify the debtor that a financing agreement has been entered into between them and that electronic payment by the debtor of invoices issued by the supplier must be made directly into the supplier's nominated account with the bank 18.

The supplier then delivers goods and/or services to the debtor, together with an invoice and a delivery note. In FIG. 1 of the drawings, the supply of goods and/or services is indicated by an arrow 20 and the delivery of the invoice and delivery note is indicated by an arrow 22. When the debtor receives the goods and/or services, they are checked in accordance with the debtor's standard procedure. Typically, the debtor accounts payable transmitter 14 is located within the debtor's Accounts Payable Department. Thus, the invoice with any adjustment applicable, is sent to the debtor's Accounts Payable Department for entry into their accounts payable system for payment on the due date of the invoice. The Accounts Payable Department also enters details of invoices approved for payment into the debtor accounts payable transmitter 14.

Simultaneously with delivering the goods and/or services, invoice and delivery note to the debtor, the supplier also provides the debtor approval manager 16 with details of the issued invoice. If preferred, the information can be provided on a batch basis, with each batch including details of a plurality of invoices, whether issued to the same or different debtors. The information is transmitted from the supplier invoice transmitter 12 to the debtor approval manager 16, over the communications network, as indicated by arrow 23. Typically, the information will be transferred in data fields comprising accounting, validation, identification, security and payload fields, amongst others. An example of such a transmission which includes some of these fields is shown in FIG. 6.

Once the debtor has approved an invoice as payable and has entered the information regarding the approved invoice into the debtor accounts payable transmitter 14, the details of the approved supplier invoice is transmitted over the communications network to the debtor approval manager 16 from the debtor accounts payable transmitter 14, as indicated by arrow 24. The information may also be transmitted on a batch basis, with each batch thus including details of a number of invoices received from the same supplier and/or from different suppliers that have entered into an invoice financing agreement with the bank 18. It is possible that the debtor may approve an invoice for payment for a lower amount than submitted by the supplier, e.g. as a result of shortages or defects.

The debtor approval manager 16 receives the details of the approved invoices from the debtor accounts payable transmitter 14 and ties the information received up with the invoice details received from the supplier invoice transmitter 12 e.g. on the basis of invoice number. If the debtor approved a lower amount than was requested by the supplier, the debtor approval manager 16 adjusts the invoice amount submitted by the supplier to the lower amount approved by the debtor. In effect, the face value of the invoice is thus adjusted downwards to the value approved for payment by the debtor. The debtor approval manager 16 also checks to see if the information was sent by an approved debtor, by searching the database of approved debtors to determine if the debtor's name appears in the database. If the debtor is an approved debtor, the debtor approval manager 16 records the underwriting of the invoice by the entity providing the database of approved debtors. If the debtor is an approved debtor, if the invoice details received from the transmitter 14 tie up to a sufficient degree with the invoice details received from the transmitter 12 and if the invoice was insured, the debtor approval manager 16 indicates the status of each invoice for which details were received from the transmitter 12 and for which the aforementioned holds true, as validated or verified.

In the embodiment of the invention shown in FIG. 1, the debtor approval manger 16 compiles a register or keeps account of invoices issued by the supplier to debtors (and submitted to the debtor approval manager 16) and also keeps track of the status (i.e. validated or non-validated) of each such invoice issued by the supplier. FIG. 2 shows an example of such a register or control account of “banked” supplier invoices kept by the debtor approval manager 16, and which reflects invoice records received in two batches. Approved and validated invoices are marked with a tick mark in the column headed “V”, and the face values, adjusted when necessary, are shown.

Preferably, when an invoice has been validated, the record of the validated invoice is transferred to another register or account which includes information only on validated invoices. FIG. 3 shows an example of such a register or account kept by the debtor approval manager 16.

The information on validated invoices is automatically transmitted from time to time to the bank 18, as indicated by arrow 26. On receipt of the information, the bank 18 considers extending credit to the supplier. If the bank 18 decides to give further credit to the supplier, it does so by lifting the overdraft limit of the supplier's account with the bank with an amount which is a predetermined, agreed percentage of the validated face value (the original face value or the adjusted face value, as the case may be) of the validated invoice, e.g. 70%. In effect, the bank thus provides the supplier with an overdraft facility or revolving credit facility equal to at least the agreed percentage of the validated face value of the validated invoices. As will be appreciated, the information on validated invoices transmitted to the bank 18 may merely consist of an indication of the new overdraft limit to be applied to or recommended for the supplier's account with the bank 18. It is thus not necessary to transmit actual details of validated invoices, although naturally the system 10 can easily be configured to do so if desired.

The bank 18 provides the supplier with a statement of the revolving credit account which the supplier has with the bank. An example of such a statement is shown in FIG. 4. This account functions also as a normal bank current account, but with a varying overdraft limit.

For each invoice submitted, or accepted for financing by the bank 18, a user or transaction fee is charged by the bank 18, as are shown by the “Validation Fees” entries on the account statement shown in FIG. 4. Furthermore, the account statement shows, for example, any fixed overdraft limit provided by the bank 18 to the supplier in respect of any credit arrangement outside of the invoice financing agreement, and the varying overdraft limit provided by the bank 18 to the supplier on the strength of the financed invoices. The revolving credit account of the supplier with the bank is typically updated daily, with the statement typically being sent monthly.

A portion of the user or transaction fee is paid by the bank 18 to the entity operating the debtor approval manager 16, as indicated by arrow 28 in FIG. 1. An underwriting premium, typically based on the face value of the validated invoice to which it relates, is also credited to the account of an underwriter, as indicated by arrow 30. This underwriting fee or premium is used by the underwriter (typically but not necessarily the entity providing and maintaining the database of approved debtors) to provide cover to the bank to protect the bank against non-payment or partial payment of a validated financed invoice by the debtor.

When the debtor pays a financed invoice, the nominated current account of the supplier with the bank 18 is credited with the amount of the payment. Assuming that the invoice is paid in full, 70% of the payment has the effect of cancelling out the portion of the overdraft provided to the supplier on the strength of that invoice and 30% is retained to the credit of the supplier's current account. As will be appreciated, at all times, the bank 18 is only exposed to 70% of the value of the invoices approved by the debtor and validated by the debtor approval manager 16. The balance of 30% is held as a contingency reserve provision as security for user fees, settlement discounts, goods returned, defective workmanship, advertising allowances, and the like. The bank 18 also has additional security in that it takes cession of all of the invoices, details of which were transmitted from the supplier invoice transmitter 12 to the debtor approval manager 16, in terms of the agreement between the supplier and the bank 18.

In the event that details of an invoice was submitted from the supplier invoice transmitter 12 to the debtor approval manager 16, but the invoice was not validated by the debtor approval manager 16, the invoice will not be accepted for financing and will remain reflected as a non-validated invoice in the register of “banked” invoices kept by the debtor approval manager 16. If for any reason the invoice later becomes validated by the debtor approval manager 16, the invoice record is transferred to the register or account of validated invoices and the invoice is considered for financing, possibly leading to an increase in the overdraft facility of the supplier equal to the predetermined percentage, e.g. 70% of the face value of the invoice.

Referring to FIG. 5 of the drawings, reference numeral 100 generally indicates another embodiment of an invoice financing system in accordance with the invention. The system 100 is similar to the system 10 and, unless otherwise indicated, the same reference numerals are used to indicate the same or similar parts or features.

In addition to the supplier invoice transmitter 12, the debtor accounts payable transmitter 14 and the debtor approval manager 16, the system 100 also includes an electronic credit facility manager 34 operated by the bank 18. Unlike FIG. 1, FIG. 5 also indicates an entity 32 which supplies the database of approved debtors. Thus, the debtor approval manager 16 is in online communication with a computer operated by the entity 32, which computer houses the database of approved debtors. The entity 32 is also an underwriter. The communication between the debtor approval manager 16 and the computer operated by the entity 32 is indicated by reference numeral 38.

In the system 100, the credit facility manager 34 is configured online to receive details of invoices transmitted from the supplier invoice transmitter 12, as indicated by arrow 36. The credit facility manager 34 is configured to manage a control account or register, which includes records of submitted details of supplier invoices. This is in contrast to the system 10, in which the debtor approval manager 16 compiles a register or control account of invoices supplied by the supplier to debtors. The register or control account of the manager 34 includes a sub-register or sub-account in which details of all invoices received from the supplier invoice transmitter 12 are captured, and another sub-register or sub-account which includes details of only those invoices validated or verified by the debtor approval manager 16. These sub-accounts can be identical to the banked invoice account and the validated invoice account shown in FIGS. 2 and 3 of the drawings.

The system 100 is operated in a similar fashion to the system 10 in order to finance an invoice. However, in the system 100, invoice details are also transmitted from the supplier invoice transmitter 12 to the credit facility manager 34, in addition to invoice details being transmitted to the debtor accounts payable transmitter 14 and the debtor approval manager 16. In the system 100, as the database of approved debtors is not internal to the debtor approval manager 16, the debtor approval manager 16 has to communicate with the computer operated by the entity 32, as shown by the arrow 38, in order to obtain information on the creditworthiness of debtors and to provide the entity 32 with sufficient information so that the entity 32 can underwrite a particular invoice for a debtor in the database of approved debtors. When the debtor approval manager 16 has performed its routine to validate or verify an invoice for which details were received from the supplier invoice transmitter 12 and the debtor accounts payable transmitter 14, the status of the invoice is transmitted to the credit facility manager 34 as indicated by the arrow 26. The credit facility manager 34 then updates the status of the invoice in the banked invoice account and, if the invoice was validated, copy the record to the validated invoice account, whereafter the bank 18 decides whether or not to provide credit to the supplier equal to the predetermined percentage, e.g. 70%, of the face value of the validated invoice.

The electronic invoice financing system 10, 100, as illustrated, substantially speeds up the process of invoice financing and has the potential of reducing the risk to which a financial institution involved in invoice financing is exposed. The system 10, 100, achieves this by matching invoice details received from a supplier and a debtor, adjusting the face value of the invoice where necessary, and validating the invoice if the details received from a supplier and debtor correspond to a sufficient degree and if the debtor is an approved debtor. At the same time, the system 10, 100 allows an invoice financing transaction to be underwritten. The Applicant suspects that the system 10, 100 will be very useful in making available working capital to entrepreneurs and small and medium enterprises, for which access to working capital is not otherwise easily available.

1. An electronic invoice financing system which includes
a supplier invoice transmitter configured to transmit details of a supplier invoice electronically from a supplier to a debtor approval manager operable by, or operable to assist, at least one financial institution which finances invoices issued by the supplier;
a debtor accounts payable transmitter which is programmable electronically to transmit details of a supplier invoice approved for payment, to said debtor approval manager; and
said debtor approval manager which includes, or which has access to, a database of approved debtors and which is configured to receive invoice details from the supplier invoice transmitter and from the debtor accounts payable transmitter, the debtor approval manager being programmed or programmable selectively to indicate the status of an invoice for which details were received from the supplier invoice transmitter as validated or verified, or non-validated, depending on whether or not corresponding invoice details were also received from the debtor accounts payable transmitter and whether or not the debtor is an approved debtor, and then either (I) to transmit the invoice status information to a financial institution so that the financial institution can then consider providing credit to the supplier, to the value of a predetermined percentage of the value of the validated supplier invoice, or (II) to provide credit on behalf of the financial institution to the supplier, to the value of a predetermined percentage of the value of the validated supplier invoice.

2. The electronic invoice financing system as claimed in claim 1, in which the supplier invoice transmitter and/or the debtor accounts payable transmitter is/are configured to transmit the invoice details online to the debtor approval manager assisting the financial institution or operated by or on behalf of the financial institution.

3. The electronic invoice financing system as claimed in claim 1, which includes a credit facility manager operated or operable by the financial institution and configured electronically to receive invoice details from the supplier invoice transmitter, the supplier invoice transmitter being configured electronically to transmit details of a supplier invoice to the credit facility manager, in addition to transmitting details of a supplier invoice to the debtor approval manager.

4. The electronic invoice financing system as claimed in claim 3, in which the debtor approval manager or preferably the credit facility manager is configured to manage a supplier account on behalf of the financial institution.

5. The electronic invoice financing system as claimed in claim 4, in which the debtor approval manager or preferably the credit facility manager is also configured to provide the financial institution and/or the supplier with a statement of the supplier's account with the financial institution.

6. The electronic invoice financing system as claimed in claim 5, in which the debtor approval manager is configured to transmit invoice status information to the financial institution in order for the financial institution to consider providing credit or finance to the supplier, the status information being in the form of said account statement or merely being in the form of a credit limit advice, thereby informing the financial institution of what the credit limit on the supplier's account must be, instead of actual individual invoice statuses.

7. The electronic invoice financing system as claimed in claim 5, in which the debtor approval manager is configured to transmit actual invoice status information to the financial institution in order for the financial institution to consider providing credit or finance to the supplier.

8. The electronic invoice financing system as claimed in claim 5, in which the account statement also shows the amounts of any user or transaction fees charged to the supplier for making use of the invoice financing system.

9. The electronic invoice financing system as claimed in claim 4, in which the debtor approval manager is configured to manage the supplier's account with the financial institution, the debtor approval manager being configured to transfer at least a portion of any user or transaction fees into an account, or to credit said account, of an entity managing or operating the debtor approval manager, and/or providing debtor creditworthiness information to the debtor approval manager.

10. The electronic invoice financing system as claimed in claim 3, in which the credit facility manager is configured to transfer at least a portion of any user or transaction fees charged to the supplier, into an account, or to credit said account, of an entity managing or operating the debtor approval manager, and/or providing debtor creditworthiness information to the debtor approval manager.

11. The electronic invoice financing system as claimed in claim 4, in which the debtor approval manager is configured to manage the supplier's account with the financial institution, the debtor approval manager also being configured to transfer an underwriting premium, charged to the supplier, into an account, or to credit said account, of an entity underwriting the financial institution for potential losses that may be incurred by the financial institution as a result of providing credit to the supplier on the basis of a validated invoice.

12. The electronic invoice financing system as claimed in claim 3, in which the credit facility manager is configured to transfer an underwriting premium, charged to the supplier, into an account, or to credit said account, of an entity underwriting the financial institution for potential losses that may be incurred by the financial institution as a result of providing credit to the supplier on the basis of a validated invoice.

13. The electronic invoice financing system as claimed in claim 1, in which the debtor approval manager is configured electronically to transmit details of a non-validated invoice to the financial institution.

14. The electronic invoice financing system as claimed in claim 3, in which the debtor approval manager and/or the credit facility manager is/are configured to manage a control account or register, which control account or register includes records of submitted details of supplier invoices.

15. The electronic invoice financing system as claimed in claim 14, in which the records include details of validated and non-validated invoices and thus include a validation status indicator, the debtor approval manager being configured to change the status indicator of a non-validated invoice in a record to a validated invoice under predetermined conditions, and then either (I) to transmit the revised invoice status information to a financial institution so that the financial institution can then consider providing credit to the supplier, to the value of a predetermined percentage of the value of the validated supplier invoice, or (II) to provide credit on behalf of the financial institution to the supplier, to the value of a predetermined percentage of the value of the validated supplier invoice.

16. The electronic invoice financing system as claimed in claim 14, in which the credit facility manager is configured to manage a control account or register which includes records of submitted details of supplier invoices, the control account including at least two sub-accounts, one sub-account including details of all invoices received from the supplier invoice transmitter and one sub-account including details of only those invoices validated or verified by the debtor approval manager.

17. An electronic programmable debtor approval manager which includes, or which has access to, a database of approved debtors, the debtor approval manager being configured to receive, over a communications network, invoice details from a supplier and a debtor, the debtor approval manager further being programmed or programmable to check if corresponding invoice details were received from the supplier and from the debtor and to access the database to check if the debtor is an approved debtor, and then selectively to indicate the status of an invoice for which details were received from the supplier as validated or verified, or non-validated, depending on whether or not corresponding invoice details were also received from the debtor and whether or not the debtor is an approved debtor.

18. The electronic debtor approval manager as claimed in claim 17, which is configured either (I) automatically to transmit the invoice status information to a financial institution so that the financial institution can then consider providing credit to the supplier, to the value of a predetermined percentage of the value of the validated invoice, or (II) automatically to provide credit on behalf of the financial institution to the supplier, to the value of a predetermined percentage of the value of the validated invoice.

19. The electronic debtor approval manager as claimed in claim 18, which is configured to manage an account for the supplier on behalf of the financial institution, and to provide the financial institution and/or the supplier with a statement of the supplier's account with the financial institution.

20. The electronic debtor approval manager as claimed in claim 19, which is configured to transmit invoice status information to the financial institution in order for the financial institution to consider providing credit or finance to the supplier, the status information being in the form of said account statement or merely being in the form of a credit limit advice, thereby informing the financial institution of what the credit limit on the supplier's account must be, instead of actual individual invoice statuses.

21. The electronic debtor approval manager as claimed in claim 19, which is configured to transmit actual invoice status information to the financial institution in order for the financial institution to consider providing credit or finance to the supplier.

22. A method of financing an invoice, the method including
validating or verifying with an electronic programmable debtor approval manager, an invoice issued by a supplier to a debtor, by the electronic programmable debtor approval manager receiving online, from both the supplier and the debtor, details of said invoice issued by the supplier to the debtor and automatically comparing the invoice details received from the supplier and from the debtor, and further receiving or obtaining online confirmation that the debtor is creditworthy; and
the electronic programmable debtor approval manager automatically providing credit to the supplier, or automatically recommending the provision of credit by a financial institution to the supplier, to the value of a predetermined percentage of the value of the validated invoice.

23. The method as claimed in claim 22, in which receiving online details of an invoice issued by a supplier to a debtor includes the electronic programmable debtor approval manager receiving said details over a secure electronic communications system or network.

24. The method as claimed in claim 22, in which automatically recommending the provision of credit by the financial institution to the supplier includes automatically advising the financial institution that a particular invoice has been validated or verified, and automatically advising the financial institution of the face value of the invoice for which the invoice has been validated.

25. The method as claimed in claim 22, which includes automatically taking out insurance in respect of the risk, or underwriting the risk, that the debtor may default on any payment due in terms of the invoice.

26. The method as claimed in claim 25, which includes automatically raising a user or transaction fee, payable by the supplier, for financing the invoice and automatically crediting an underwriter with an underwriting premium for underwriting or insuring the financing of the invoice.

27. The method as claimed in claim 22, which includes automatically raising a user or transaction fee, payable to by the supplier, for financing the invoice and automatically crediting a credit guarantee entity with a portion of the transaction or user fee for providing information on the creditworthiness of the debtor and/or for monitoring the creditworthiness of the debtor.

28. A method of providing support to a financial institution involved in invoice financing, which method includes
receiving online details of an invoice issued to a debtor, with confirmation from the debtor that the invoice was received from a supplier to the debtor and that the invoice is payable by the debtor;
automatically investigating the creditworthiness of the debtor; and
automatically, by means of an electronic programmable debtor approval manager, validating or verifying the invoice online for a financial institution in order for the financial institution to consider providing credit to the supplier on the strength of the validated invoice, the invoice being validated automatically by the electronic programmable debtor approval manager only if the automatic investigation of the creditworthiness of the debtor has confirmed that the debtor is creditworthy.

29. The method as claimed in claim 28, which includes receiving online, over a communications network, details of said invoice from said supplier and from said debtor.

30. The method as claimed in claim 29, in which the invoice is validated by the electronic programmable debtor approval manager only if the invoice details received from the supplier correspond to a predetermined degree with the invoice details received from the debtor.

31. The method as claimed in claim 29, in which the invoice is validated by the electronic programmable debtor approval manager for a lower amount where the invoice details received from the debtor is for said lower amount, and where the lower amount is less than the face value of the invoice as included in the invoice details received from the supplier.

32. The method as claimed in claim 28, in which automatically investigating the creditworthiness of the debtor includes automatically checking or searching an electronic database of approved debtors to determine if the debtor is an approved debtor.

33. The method as claimed in claim 28, in which the invoice is validated or verified only if payment or partial payment of the invoice is automatically assured by an underwriter.
